(19) United States
(12) Patent Application Publication
(10) Pub. No.: US 2018/0043612 A1
(43) Pub. Date: Feb. 15, 2018

(54) DEVICE FOR PRINTING A THREE DIMENSIONAL COSMETIC ARTICLE FROM A BUILD MATERIAL COMPRISING A COSMETIC FORMULA

(71) Applicant: ELC MANAGEMENT LLC, Melville, NY (US)

(72) Inventors: Timothy Patrick Gray, New York, NY (US); Isaac David COHEN, Brooklyn, NY (US); Agostinho MARTINS, New Hyde Park, NY (US); Bruce Laurence VICTOR, Great River, NY (US); Charles Aaron CURTISS, Norwalk, CT (US); Madalyn Ellice PAPPAS, Somerville, MA (US)

(21) Appl. No.: 15/669,105

(22) Filed: Aug. 4, 2017

Related U.S. Application Data
(60) Provisional application No. 62/374,153, filed on Aug. 12, 2016.

(51) Int. Cl. B29C 64/106; B33Y 30/00; B29C 64/386; B29C 64/209; B33Y 50/02

(52) U.S. Cl. CPC B29C 64/106; B29C 64/209; B33Y 50/02; B29C 64/386; B33Y 30/00

(57) ABSTRACT

A device printing a three dimensional cosmetic article from a build material including a cosmetic formula has an extruder, a build plate, a controller and a positioning system. The controller is programmed to instruct the positioning system to position the extruder relative to the build plate. The extruder includes a piston extrusion system. The build material is provided to the extruder as a pre-formed stick. The build material is extruded onto a substrate to form the article. The build plate includes a sizing system for receiving substrates of various sizes.

### BACKGROUND OF THE INVENTION

### Field of the Invention

The present invention relates to devices for three dimensional printing. In particular, the present invention is directed to a device for printing by fusion deposition a three dimensional cosmetic article from a build material comprising a cosmetic formula.

### Description of the Prior Art

Three dimensional (“3D”) printers for additive fabrication are well known. An example of such a printer is disclosed in U.S. Pat. No. 8,529,240 to Mayer. The device disclosed by Mayer uses a controller and other hardware, a positioning assembly with a stepper motor, an extruder and a build plate to fabricate an article from a 3D computer model via additive deposition of plastic build material. Relatively rigid plastic filament build material is fed from a spool into the extruder by the stepper motor where it is melted by the heater and extruded through a nozzle. Mayer does not disclose a piston for advancing the build material.

U.S. Pat. Appln. No. 2015/0314141 to Choi discloses a printer modified to receive and process cosmetic components. The printer is described as a device that deposits substances (dyes, pigments, etc.) at a very specific location of an underlying substrate to create a chosen desired color that is formed on the substrate. The substrate is a pre-existing supply or article of cosmetic material. In other words, Choi discloses a printer for selectively printing color to an existing cosmetic formula substrate or article, but does not disclose printing a three-dimensional cosmetic article from a build material comprising a cosmetic formula.

U.S. Pat. No. 8,172,473 to Salciarini discloses a method for manufacturing a cosmetic applicator using photopolymerization or sintering via laser light to solidify flowing build material in slices. The article produced is a cosmetic applicator (mascara brush, comb, etc.), not a cosmetic article made from a build material comprising a cosmetic formula.

WO/2016/020435 to Jaunet et al. discloses a method for additive manufacturing of a 3D object comprising a cosmetic composition by direct projection, but the method is described as including a pump (not shown or described) to spray (direct projection) successive layers of cosmetic build material. The build material is sprayed in droplets of relatively small size to form thin successive layers. The reference does not include an extruder for extruding build material in relatively thick layers.

WO/2016/020442 to Jaunet et al. discloses a method for additive manufacturing of a 3D object comprising a cosmetic composition by direct projection, but the method is described as using a photoactivatable material and illumination to activate the photoactivatable material. WO/2016/020454 to Jaunet et al. discloses a method for additive manufacturing of a 3D object comprising a cosmetic composition by application of a powder binding activator. WO/2016/020447 to Jaunet et al. discloses a method for additive manufacturing of a 3D object comprising a cosmetic composition by application of a photoactivatable material onto a powder. The present invention does not include photoactivatable material, powder binding activator or application of a photoactivatable material onto a powder.

Known 3D printers are not suitable for producing 3D articles from a build material comprising a cosmetic formula in successive thick layers by fusion deposition. Build materials comprising cosmetic formulas contain components such as silicones and waxes that are not readily printed in thick layers using known 3D printing technology. Such components may cause the build materials comprising cosmetic formulas to be softer in the pre-build and post build state, and to flow, harden and cool differently during the build process when compared to typical relatively hard plastic build materials used for 3D printing, particularly when printed in relatively thick successive layers.

Accordingly, there is a need for a device for printing a three dimensional cosmetic article from a build material comprising a cosmetic formula wherein the device includes an extruder for extruding successive layers of build material.

### BRIEF SUMMARY OF THE INVENTION

It is an object of the invention to provide a device for printing a three dimensional cosmetic article from a build material comprising a cosmetic formula.

It is another object of the invention to provide a build material extruder for a device for printing a three dimensional cosmetic article from a build material comprising a cosmetic formula.

It is another object of the invention to provide an annular cooling means for a device for printing a three dimensional cosmetic article from a build material comprising a cosmetic formula.

It is another object of the invention to provide an improved nozzle including a hemispherical chamber for a device for printing a three dimensional cosmetic article from a build material comprising a cosmetic formula.

It is another object of the invention to provide a device that facilitates printing of build materials with glass-transition temperature ranges wider than polymers that are typically used in 3D printing.

### BRIEF DESCRIPTION OF THE DRAWINGS

FIG. 1 is front, top and left side perspective view of a 3d printer incorporating the device of the invention;

FIG. 2 is front, top and left side perspective enlarged view of the device;

FIG. 3 is an enlarged view of the extruder of the device;

FIG. 4 is a sectional view of the extruder shown in FIG. 3;

FIG. 5 is a sectional view of the extruder shown in FIG. 3;

FIG. 6 is an exploded perspective view of the build plate of the device;

FIG. 7 is an assembled perspective view of the build plate in FIG. 6;

FIG. 8 is an exploded perspective view of the build plate of the device showing alternative inserts for the build plate;

FIG. 9 is a top, front and left side perspective view of the fan assembly;

FIG. 10 is a bottom, front and left side perspective view of the fan assembly shown in FIG. 9;

FIG. 11 is a top, front and left side perspective view of the fan duct of the assembly shown in FIGS. 9 and 10;

FIG. 12 is a top, rear and right side perspective view of the fan duct of the assembly shown in FIGS. 9 and 10;

FIG. 13 is an exploded top, front and left side perspective view of the fan duct of the assembly shown in FIGS. 9 and 10;

FIG. 14 is a bottom and front perspective view of the device; and

FIG. 15 is a front and top perspective and sectional view of various embodiments of a build material stick.

### DETAILED DESCRIPTION OF THE INVENTION

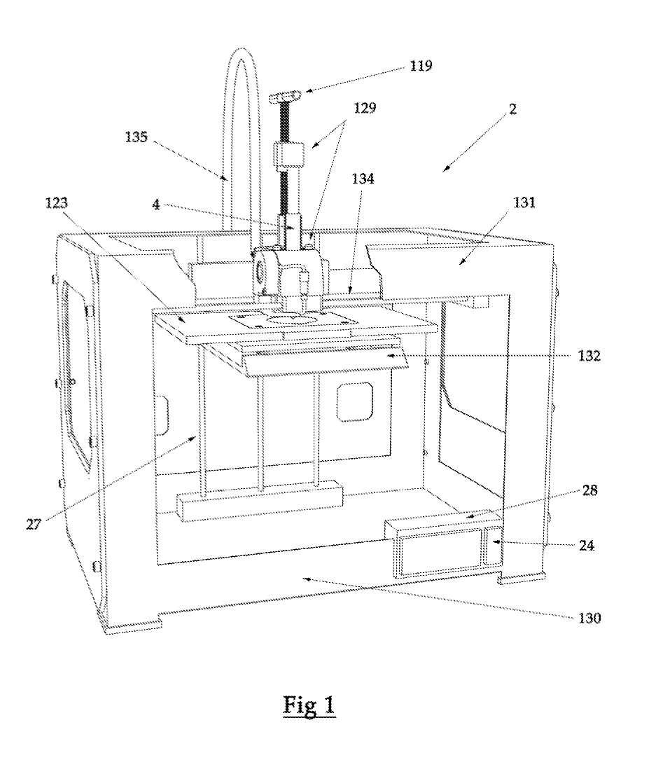

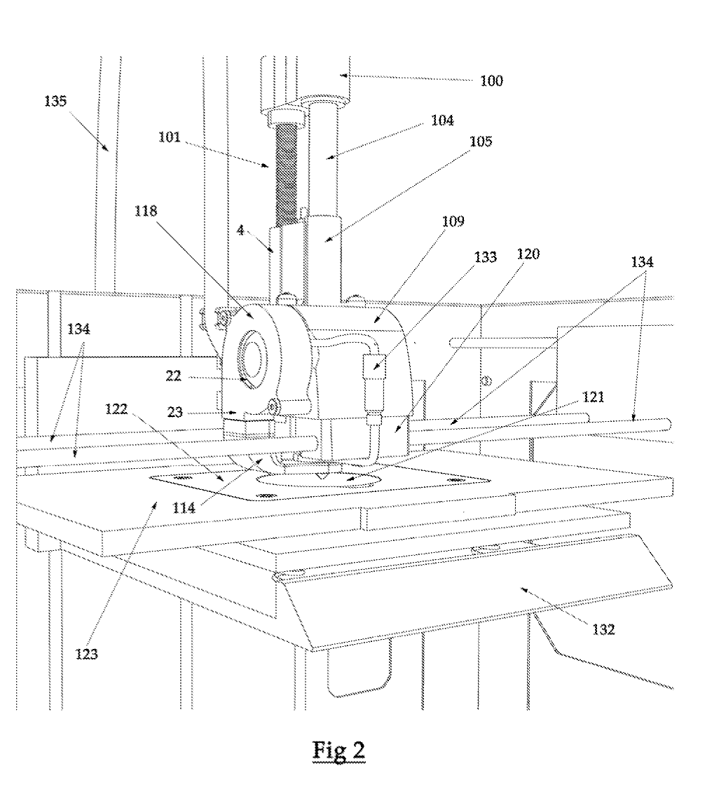

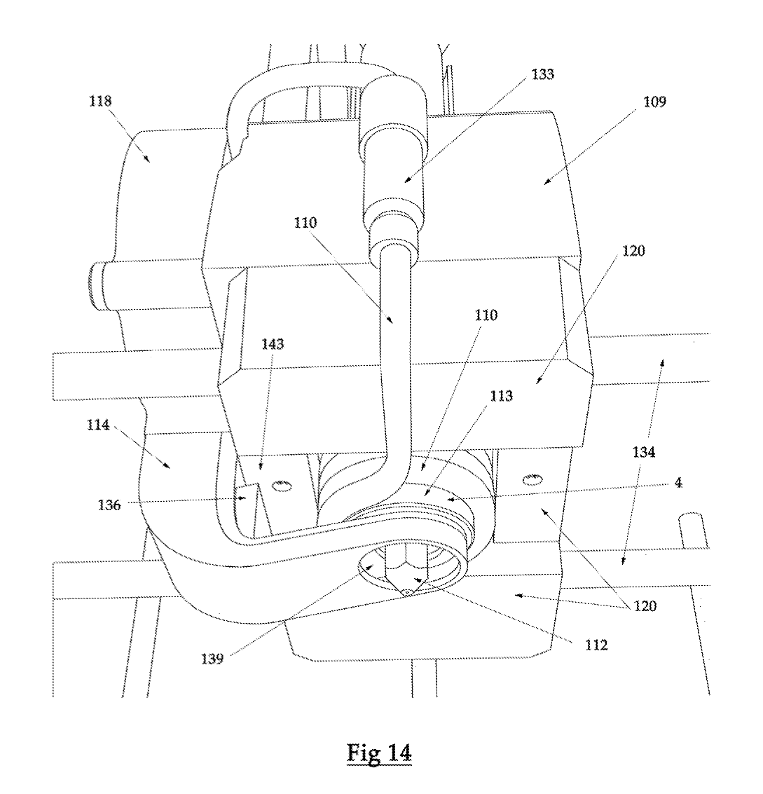

Referring now to FIGS. 1-15, a device for printing a three dimensional article from a build material comprising a cosmetic formula is shown generally at reference number 2. A print head assembly 129 is supported on a base machine 130, such as, for example, a MakerBot Replicator 2 or similar printer. The base machine has a positioning assembly (shown generally at 27) including a top frame rail 131, x-axis support platform 132 and gantry rails 134 for the supporting and positioning the print head assembly 129. A flexible wiring sheath 135 connects the print head assembly 129 to the base machine 130 in electrical communication. The print head assembly 129 includes an extruder 4 with a barrel 105 having an inner wall 5 defining a cylinder 6. The cylinder 6 has a first end 7 and a second end 8. A piston 104 is mounted in the first end 7 of the cylinder 6 such that the piston 104 is able to advance and retract in the cylinder 6. The piston 104 has a front wall 9 and a rear wall 10 connected by an outwardly directed sidewall 11. The sidewall 11 is shaped and dimensioned to be received and fit closely in the cylinder 6. The front wall 9 of the piston 104 is directed toward the second end 8 of the cylinder 6. The piston may be made of any suitable material, but a preferred material is 6061 aluminum. A seal 106 may be provided between the sidewall 11 of the piston 104 and the inner wall 5 of the cylinder 6. The seal is preferably an elastomeric O-ring secured in a circumferential groove 3 in the sidewall 11 of the piston 104. The seal is preferably an oil-resistant Buna-N material.

A nail 113 is secured to the barrel 105 at the second end 8 of the cylinder 6. The nail 113 may be made of any suitable material, but a preferred material is 6061 aluminum. The nail 113 has a hollow portion 12 in fluid communication with the cylinder 6. At an end of the nail opposite the cylinder 6, the hollow portion 12 preferably terminates in a hemispherical chamber 111. An extrusion nozzle 112 is also secured to the opposite end of the nail 113. The nozzle 112 is a 4 mm nozzle made of brass. The extrusion nozzle 112 has a nozzle outlet 13 at a distal end and a nozzle inlet 15 at a proximal end connected in fluid communication by a nozzle duct 14. The hemispherical chamber 111 of the nail 113 is in fluid communication with the nozzle inlet 15, and the nozzle inlet 15 is in fluid communication with the nozzle outlet 13 via the nozzle duct 14.

A reservoir 16 for receiving a quantity of the build material is defined by a portion of the cylinder 6 between the front wall 9 of the piston 104 and the nozzle 112, including the hollow portion 12 and the hemispherical chamber 111 of the nail 113. The build material is preferably provided to the reservoir 16 in the form of a stick 115. The piston 104 is adapted to apply pressure to the build material stick 115 in the reservoir 16 to extrude the build material through the nozzle 112 when the piston 104 is advanced in the cylinder 6 and to apply suction to the build material stick 115 to withdraw the build material into the nozzle 112 when the piston 104 is retracted in the cylinder 6.

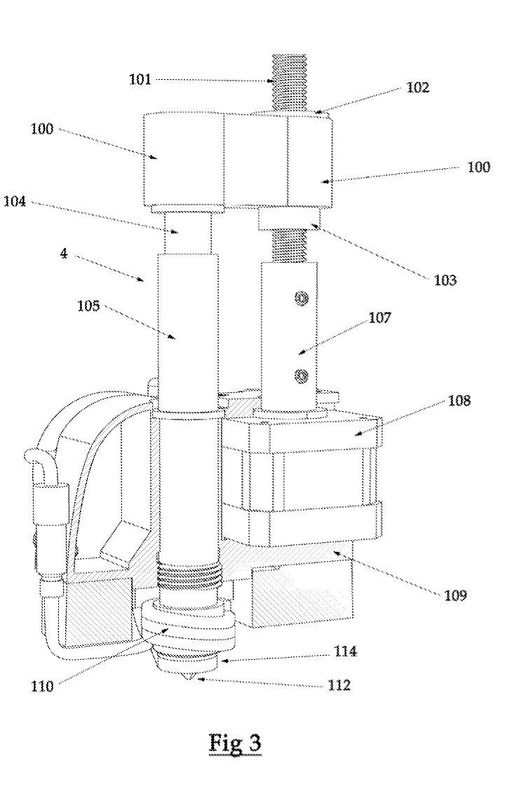

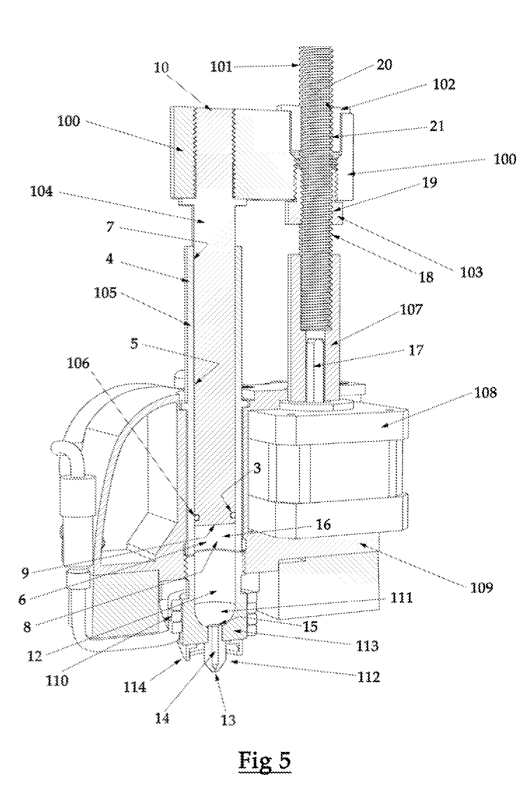

A motor 108 (FIGS. 3, 5) is connected to the piston 104 to advance and retract the piston 104 in the cylinder 6. The motor 108 may be, for example, a MakerBot Replicator 2/2X NEMA 17 Hybrid Stepper Motor. The motor 108 and barrel 105 are mounted on a supporting upper chassis 109. The chassis may be made of any suitable metal or plastic material. Alternatively, the chassis may be 3D printed from PLA build material. The motor 108 is preferably a stepper motor. The motor 108 may be connected to the piston via a linkage 100 and drive rod 101. The linkage is made from aluminum or another suitable metal or plastic material, or may be 3D printed from PLA build material. The drive rod is preferably made from steel for durability. The drive rod 101 is connected to a spindle 17 of the motor 108 by a sleeve-like connector 107. The drive rod 101 is connected to the motor 108 such that rotational movement of the spindle 17 of the motor 108 is transmitted directly to the drive rod 101. The drive rod has external threads 18. A drive nut 103 is fixedly secured to the linkage 100. The drive nut 103 has internal threads 19 that cooperatively engage the external threads 18 of the drive rod 101. Rotation of the drive rod 101 in the drive nut 103 translates rotational movement of the motor into linear movement of the linkage 100 which in turn moves the piston 104 linearly in the cylinder 6. When the motor spindle rotates in a first direction, the rotational movement of the rod is translated into linear movement of the drive nut and linkage, and in turn the piston such that the piston advances in the cylinder (moving the front wall of the piston away from the first end of the cylinder towards the second end of the cylinder). When the motor rotates in the opposite direction, the piston is retracted in the cylinder (the front wall of the piston moves away from the second end of the cylinder). A handle 119 is provided on the drive rod 101 so that the piston can be advanced or retracted manually by turning the drive rod.

Preferably, a rod bearing 102 is secured to the linkage 100. At least a portion of the drive rod 101 passes through a bore 20 in the rod bearing 102. The bore 20 of the rod bearing 102 may have internal threads 21 that cooperatively engage the external threads 18 of the drive rod 101. Alternatively, the bore may have a smooth wall (not shown). The rod bearing is positioned and adapted to secure the alignment of the drive rod 101 and linkage 100 with respect to the other parts of the extruder structure and components. The drive nut and rod bearing are made from any suitable metal or plastic material. In the present case, the drive nut and rod bearing are made from brass.

A build plate 123 (FIGS. 1, 2, 7 and 8) is located below the nozzle 112.

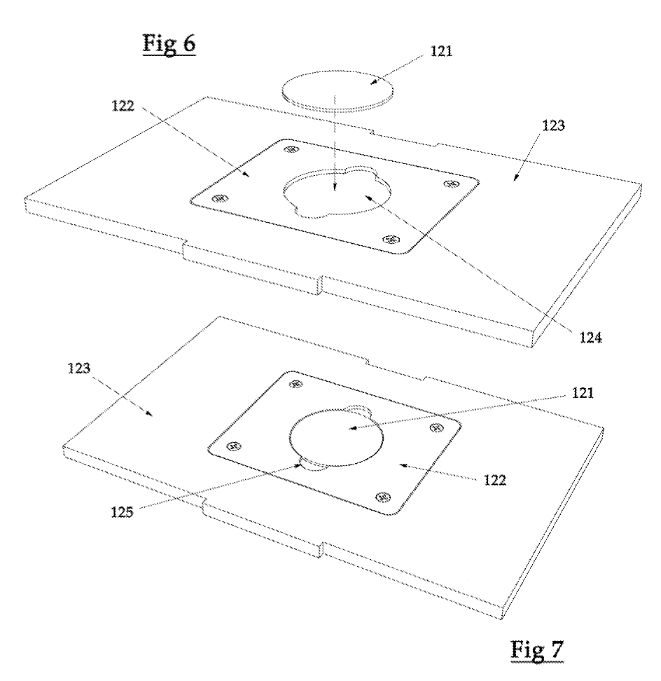

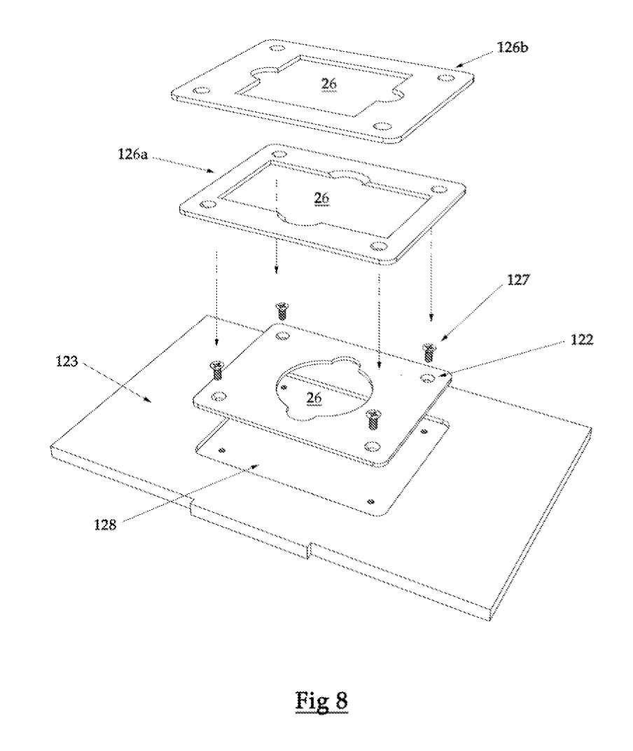

A substrate 121 for supporting the cosmetic article is removably secured on the build plate 123 between the build plate 123 and the nozzle 112 to receive the build material from the nozzle 112. The substrate may be 3D printed from PLA build material, or may be any other suitable metal or plastic material that is cosmetic formula compatible. Preferably, the build plate 123 has a substrate recess 124 cooperatively shaped to securely receive and position the substrate 121 through the printing process. The substrate recess 124 securely holds the substrate 121 in place during the printing operation. Preferably, a build plate 123 of a modular design is provided allowing substrates having different shapes, thicknesses and sizes to be inserted and held by the build plate with little or no re-tooling or modification of build plate 123. As illustrated in FIGS. 6, 7 and 8, a sizing recess 128 may be provided that is dimensioned larger than the substrate 121 to accommodate a sizing insert 122, 126a, 126b. The device 2 may be used to 3D print cosmetic articles of varying size and type. For example, the device 2 may be used to 3D print lipstick, lip balm, eye shadow, eyebrow color, cheek makeup, moisturizers or deodorant in stick or bullet form, or foundation or color makeup in cake form (for inserting in compacts), each requiring a substrate 121 of a different shape and/or dimension. A sizing insert 122, 126a, 126b may be provided for each substrate shape and/or dimension required to vary the size of the substrate recess 124 as needed (see, for example, sizing inserts 122, 126a and 126b in FIG. 8). Each sizing insert 122, 126a, 126b has a substrate void 26 (corresponding to the substrate recess 124 discussed above). The substrate void 26 is cooperatively shaped and dimensioned to receive a correspondingly shaped and dimensioned substrate 121. The substrate void 26 securely holds the substrate 121 in place in the sizing insert, which in turn is secured to the build plate, during the printing operation. Screws 127 may be provided to secure the sizing insert 122, 126a, 126b to the build plate 123. With the sizing insert 122, 126a, 126b provided in the insert recess 128, the substrate recess 124 is defined by the substrate void 26 in the sizing insert 126. An additional clearance 125 may be provided in the insert to facilitate removal of the substrate 121 including the 3D printed article after the printing process has completed. The insert system simplifies and expedites change-over of the substrate holding platform. The insert system provides an advantage over specialized, machined build plates for each different substrate size or shape. The inserts may be 3D printed or otherwise inexpensively manufactured to speed development and fabrication and allow shipping of a simple, light part, rather than an entire, larger build plate. Inserts can be made faster than a full build plate. The insert system allows faster adjustment for variable substrate thicknesses.

The positioning assembly 27 is provided to position the nozzle 112 relative to the build plate 123 in horizontal and vertical directions.

A controller 28 is coupled in a communicating relationship with the extruder 4 and the positioning assembly 27 via the wiring sheath 135. The controller 28 is programmed to position the nozzle relative to the build plate and to advance or retract the build material stick 115, such that build material is selectively advanced through the nozzle 112 to be deposited onto the substrate to fabricate the cosmetic article in a three dimensional shape.

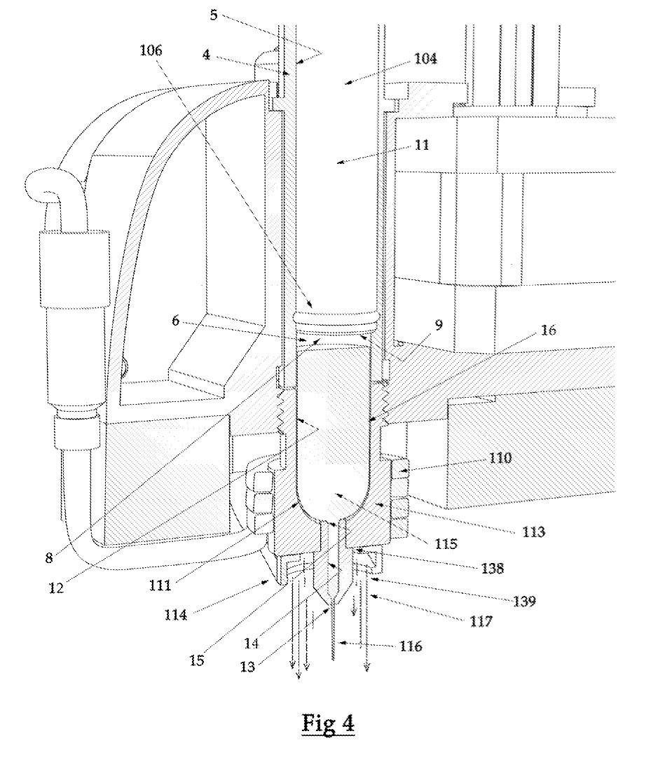

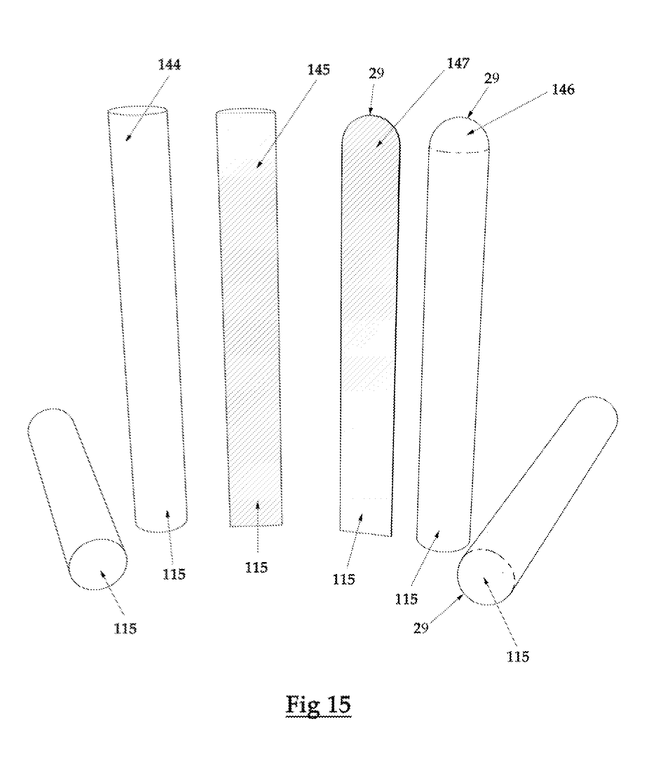

Preferably, the build material comprises the pre-formed stick 115 (shown partially extruded through the nozzle 112 in FIG. 4, and in FIG. 15 at reference numbers 144-147). An example of a build material formula is:

| Material | Approx % | |
|---|---|---|
| Castor Oil | 15.0 | |
| Caprylic/Capric Triglycerides | 3.0 | |
| Carnuba Wax | 3.0 | |
| Long Chain Alcohol | 20.0 | Preferably, alcohols greater |
| Long Chain Ester | 9.0 | than 5 methyl/methylene units |
| Citrate Ester | 10.0 | |
| Paraffin Wax | 10.0 | |
| Silicone | 5.0 | |
| Pigments | 10.0 | |
| Pearls | 5.0 | |
| Texture/Aesthetic/Optical | 10.0 | Preferably, silicas, |
| Powders | | polyurethanes, PMMA, |
| | | PSQ, etc. |

The pre-formed build material stick 115 preferably has a width in a range from 0.125 inches to 3 inches and a length in a range from 0.5 inches to 12 inches. The preferred stick is round in cross-section with a diameter of 0.5 inches and a length of 4 inches. In determining the dimensions of the stick the forces required to drive, advance, retract and extrude build material in stick form must be taken into consideration. Accordingly, the dimensions will necessarily change depending on the formula and constitution of the build material. It has been found that sticks in the range of sizes above are compatible with the operations of the device disclosed herein, including the torque produced by the stepper motor 108. As the entire print mechanism moves in sudden, reciprocating motions, keeping the mass of moving parts (e.g., the extruder and related parts) to a minimum is of prime concern. For example, an extruder dimensioned to accommodate larger sticks of build material will in turn have larger mechanical components and require more torque to drive and thus heavier motors. The relatively smaller size of the preferred stick of build material, 0.5 inches wide by 4 inches long, is suitable for use with existing hardware and software that are optimized for plastic filament feedstock (e.g., the MakerBot printer). This preferred size allows for modification of existing 3D printer hardware and software to allow printing of a cosmetic build material. Cosmetics such as, for example, lipstick, are generally fragile. Accordingly, the preferred size is suitable to provide the required strength, rigidity, degree of compressibility and a reasonable bulk required for practical printing applications. The preferred size also makes the sticks practical to handle, load, and store, especially for consumers or beauty advisors. In addition, the preferred size of the stick is close to the size of known lipstick bullets, so the same machinery and facilities can be used to cast the build material sticks.

Sticks can be molded with one end in a hemispherical shape 29 (see FIG. 15) to assist insertion and speed starting each print cycle. The hemispherical shaped end would preferably match the shape of the hemispherical chamber 111 in the nail 113.

A heating element 110, illustrated as a coil, is secured proximal to the nozzle 112. The heating element 110 is positioned and adapted to melt the build material 115 prior to extrusion from the nozzle 112. As illustrated, the heating element 110 surrounds a portion of the nail 113 adjacent to the nozzle. Heat is provided by the heating element to the nail in the vicinity of the hemispherical chamber 111. The hemispherical chamber 111 thus becomes a heating chamber for the build material. Preferably, melting of the solid or semi-solid build material is restricted to a portion of the reservoir in the nail 113, i.e., to the hemispherical chamber 111 and the nozzle 112. Restricting the amount of build material 115 that is melted at any given time prevents excess melted build material from escaping through the nozzle via gravity. By restricting the amount of build material melted at any given time, greater control and precision is provided to the extrusion process. To facilitate the restriction of melting of the build material, the barrel 105 is made from a polycarbonate plastic material that has a low thermal conductivity. Preferably, the barrel 105 is made from a plastic material that is non-heat conductive or very low heat conductive. Preferably, the material of the barrel 105 has a thermal conductivity that is less than 3 Btu/(ft h oF).

When the piston 104 advances in the cylinder 6, the build material 115 in the form of a stick is pushed from the reservoir 16 into the hemispherical chamber 111 of the nail 113, where it is heated and melted. The melted build material is pushed into the nozzle inlet 15, through the nozzle duct 14 and extruded out through the nozzle outlet 13 as a bead 116 of build material. The portion of the stick 115 that is still in the cylinder 6 does not melt because the barrel 105 is made of a material having a low thermal conductivity. The heat applied to the nail 113 and in turn to the hemispherical chamber 111, is not transferred to the barrel 105 or the build material remaining in the cylinder 6. When the piston 104 is retracted in the cylinder 6, suction is exerted on the build material 115, particularly if the build material is in solid or semi-solid stick form. This suction is in turn exerted on the liquefied build material in the hemispherical chamber 111 and the nozzle 112. Accordingly, the liquefied build material retracts sufficiently into the nozzle outlet 13 so that no excess build material drips or is applied to the article 25 being printed. As with conventional 3D printing software, the controller 28 is programmed to create a build material retraction action during normal operations to prevent droplets of melted build material from continuing to be extruded during non-printing toolpath or print head assembly motions. The O-ring seal 106 between the inner wall 5 of the barrel 105 and the piston 104 creates a partial vacuum inside the reservoir during piston retraction, thus retracting the build material along with the piston. This is preferred to effect accurate printing actions. The vacuum of the piston retraction eliminates the need to secure the build material to the piston mechanically, or to secure the build material in the reservoir mechanically (e.g., by a valve).

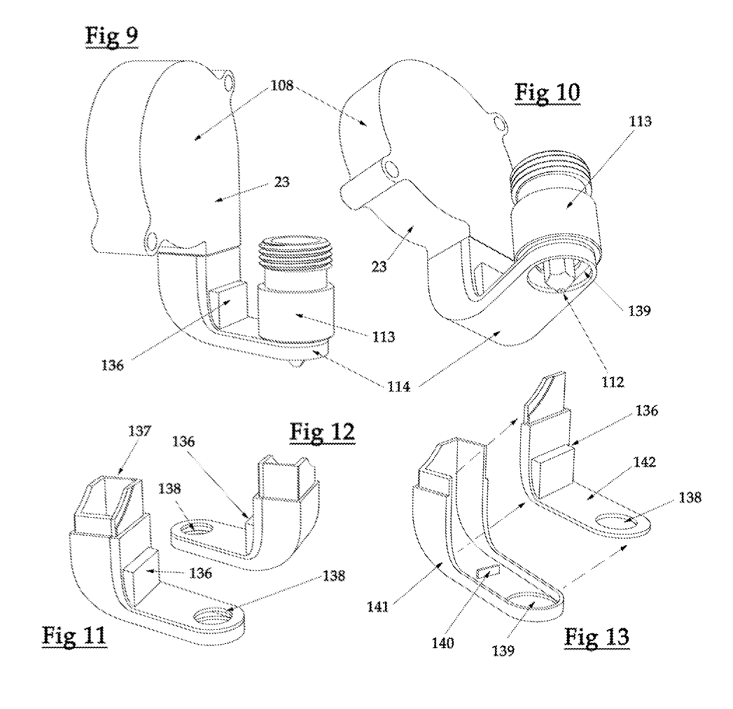

An important aspect of the invention is providing proper cooling profiles to the build material after it has been extruded and fused onto the article being printed. Accordingly, an annular airflow (indicated by downwardly directed arrows at 117 in FIG. 4) is provided around a circumference of the cosmetic article being printed to cool, fuse and harden the build material after the build material is extruded and deposited on the article. The means for cooling includes a fan 118, such as, for example, a Shark Parts 100706 Blower Fan for MakerBot Replicator 2. The fan 118 is in fluid communication with an air intake 22, a duct 114 and an air outlet 139. The fan conducts air from the intake 22 through the duct 114 to the outlet 139. The duct may be formed in two parts, bottom half 141 and top half 142. The duct parts may be made from a suitable plastic or other material by any known methods. Alternatively, the duct parts may be 3D printed from PLA build material. The duct 114 comprises a flange 137 (see FIGS. 9-13) to secure the duct to the fan housing 23. At a lower end of the duct 114, a top opening 138 is provided for insertion of the nozzle 112 through the duct 114. Opposite the top opening 138 is a bottom opening or outlet 139. The nozzle 112 projects through the top opening 138 and outlet 139 such that it is exposed below the duct 114. The body of the nail 113 substantially covers and closes the top opening 138. In contrast and as best illustrated in FIG. 10, the outlet 139 is substantially larger in diameter than the nozzle 112. Accordingly, air forced through the duct easily passes through the gap between the nozzle 112 and the perimeter of the outlet 139.

The outlet 139 is shaped and adapted to direct the air annularly and downwardly around the circumference of the article being printed (see arrows indicated at 117 in FIG. 4). Preferably, the outlet 139 has a circular configuration and is positioned coaxially around the nozzle 112 as described above and illustrated in FIG. 10. In this way, the annular airflow 117 coming from the outlet 139 is directed downwardly around the periphery of the article (not shown) being printed. In order to ensure an annular airflow from the circular duct, at least one internal baffle 140 is provided in the duct to create a uniform outflow from the air outlet 139.

To stabilize the duct with respect to the nozzle 112, a duct support 136 is provided on the duct 114. The duct support 136 presses against a bottom 143 of the lower chassis 120 (see FIG. 14). The duct support 136 stabilizes the duct 114 and the fan 118 with respect to the other components of the extruder structure.

The substrate 121 on which the article is printed may become an integral part of the article printed. It supports the article when the article is removed from the build plate and may continue to support the article when the article is secured in a primary package such as, for example, a lipstick case or a cosmetic compact. The substrate can be in the form of a flat plate as illustrated, or alternatively, may be a cup or a pan (not shown), such as a cup that holds a lipstick bullet in a lipstick riser mechanism, or such as a pan that holds a cake of color cosmetic in a compact. The substrate 121 may be made of any suitable material, such as, for example, paper, foil, plastic sheet, paperboard, molded plastic piece, metal, etc.

To further enhance the cooling capability of the device, the fan is a variable speed fan, and the device has a switch 24 for selecting a speed of the variable speed fan to adjust the rate of cooling of the article being printed. For example, the fan speed may be selectively adjusted for printing an article with a specific part geometry or part size requiring less or more cooling air. The fan speed may be adjusted for printing a build material having a formula requiring less or more cooling air. Sensors (not shown) may be provided to the device to automatically adjust temperatures for a particular formula, size, geometry, etc.

The device as claimed provides at least the following advantages. The device permits printing of build materials with glass-transition temperature ranges significantly wider than polymers that are typically used in 3D printing or fused deposition modeling (FDM) printing. Traditional polymers such as ABS, Nylon, PET and PLA used in traditional 3D or FDM printing are selected and formulated precisely for their ability to melt and solidify quickly and predictably due to sharply-defined glass transition temperatures. In contrast, cosmetic products typically have, for example, waxes, oils, silicones and other ingredients that give a build material that includes a cosmetic formula a much wider glass transition temperature or even multiple glass transition temperatures. Some of these build materials are comprised mostly of solid waxes and liquid oils which form a structure called a wax-oil gel. The device as claimed allows wax-oil gels to be printed at temperatures lower than the drop point and standard processing temperatures. Lower-temperature 3D or FDM printing of cosmetic materials allows a higher degree of print accuracy as the material is not fully liquefied, which it would be at a standard processing temperature. The print-useful glass transition range typically spans 10° C. for typical 3D or FDM printing polymer build materials. In contrast, the print-useful glass transition range for cosmetic formula based build materials, including, for example, wax-oil gels, typically spans over 20° C.

Traditional polymers such as ABS, Nylon, PET and PLA used in traditional 3D or FDM printing are selected and formulated precisely for their ability to melt and solidify quickly and predictably. This is necessary as those materials are formed as filament feedstock and fed into the melting zone as a continuous strand. While filament feedstock systems have practical advantages, their feedstock drive mechanisms require the feedstock to be rigid and hard in order to advance the strand by applying frictional force to the sides of the filament feedstock. In contrast, cosmetic based build materials such as lipstick and other relatively soft cosmetic materials are too malleable to print effectively as filament feedstock. The piston drive extruder of the present device, particularly when used with a pre-formed stick of build material to enhance the advance and retract function of the system, solves the problem of feeding cosmetic based build materials for fusion deposition modeling. The piston extruder provides a new and unique method for feeding cosmetic based build material to 3D print a cosmetic article. The device also distinguishes over systems already developed for chocolate and other consumables wherein the build material is fully-melted in the reservoir. In the present invention the piston, particularly when used with pre-formed stick of cosmetic build material, precisely controls back-and-forth motion of the build material in the nozzle. The precise back and forth motion of the build material in the nozzle is required to create accurate prints and avoid excess material extrusion. Accordingly, the device is more accurate than a system with a fully-melted build material.

Also, as the feedstock may remain solid until the point of extrusion, heavier formula ingredients do not separate out within the reservoir as they can do in fully-melted feed systems. This is critical for cosmetic products where dense minerals may be critical components of the formulas, and premature formula separation is often a problem.

It is understood that various modifications and changes in the specific form and construction of the various parts can be made without departing from the scope of the following claims.

What is claimed is:

1. A device for printing a three dimensional cosmetic article from a build material comprising a cosmetic formula, the device comprising:
an extruder including:
a barrel having an inner wall defining a cylinder, the cylinder having a first end and a second end;
a piston mounted in the first end of the cylinder such that the piston is able to advance and retract in the cylinder, the piston having a front wall and a rear wall connected by an outwardly directed sidewall, the sidewall shaped and dimensioned to fit closely in the cylinder, the front wall of the piston directed toward the second end of the cylinder;
an extrusion nozzle secured to the second end of the cylinder;
a reservoir for receiving a quantity of the build material, the reservoir defined by a portion of the cylinder between the front wall of the piston and the nozzle, the piston adapted to apply pressure to the build material to extrude the build material through the nozzle when the piston is advanced in the cylinder and to apply suction to the build material to withdraw the build material into the nozzle when the piston is retracted in the cylinder; and
a motor connected to the piston to advance and retract the piston; and
a build plate located below the nozzle;
a substrate for supporting the cosmetic article, the substrate removably secured on the build plate between the build plate and the nozzle to receive the build material from the nozzle;
a positioning assembly that positions the nozzle relative to the build plate; and
a controller coupled in a communicating relationship with the extruder and the positioning assembly, the controller programmed to position the nozzle relative to the build plate and to advance or retract the build material, such that build material is selectively advanced through the nozzle to be deposited onto the substrate to fabricate the cosmetic article in a three dimensional shape.

2. The device of claim 1 wherein the build material comprises a pre-formed stick.

3. The device of claim 1 further comprising a linkage connecting the piston to a drive rod having external threads, the drive rod connected to a spindle of the motor.

4. The device of claim 3 further comprising a drive nut fixedly secured to the linkage, the drive nut having internal threads cooperatively engaging the external threads of the drive rod.

5. The device of claim 4 further comprising a rod bearing secured to the linkage and receiving at least a portion of the drive rod, the rod bearing adapted to secure the alignment of the drive rod with respect to the piston.

6. The device of claim 4 wherein the motor is a stepper motor.

7. The device of claim 1 wherein the motor is a stepper motor.

8. The device of claim 1 further comprising a seal between the sidewall of the piston and the inner wall of the cylinder.

9. The device of claim 8 wherein the seal is an elastomeric O-ring.

10. The device of claim 1 further comprising a heating element secured proximal to the nozzle, the heating element adapted to melt the build material prior to extrusion from the nozzle.

11. The device of claim 1 further comprising means for providing an annular airflow around a circumference of the cosmetic article being printed to cool, fuse and harden the build material after the build material is deposited.

12. The device of claim 11 wherein the means for cooling includes a fan in fluid communication with an air intake, a duct and an air outlet, the fan conducting air from the intake through the duct to the outlet, the outlet adapted to direct the air annularly around the circumference of the article being printed.

13. The device of claim 12 wherein the outlet has a circular configuration and is positioned coaxially around the nozzle.

14. The device of claim 1 wherein the barrel is made from a material that has a low thermal conductivity.

15. The device of claim 14 wherein the thermal conductivity is less than 3 Btu/(ft h ° F.).

16. A device for printing a three dimensional cosmetic article from a build material comprising a cosmetic formula, the device comprising:
an extruder adapted to heat and extrude the build material in a melted state through an extrusion nozzle;
a build plate located below the nozzle;
a substrate for supporting the cosmetic article, the substrate selectively secured on the build plate between the build plate and the nozzle to receive the build material from the nozzle;
a positioning assembly that positions the nozzle relative to the build plate;
a controller coupled in a communicating relationship with the extruder and the positioning assembly, the controller programmed to position the nozzle relative to the build plate and advance the build material through the nozzle to deposit the build material onto the substrate to fabricate the cosmetic article in a three dimensional shape; and
means for providing a cooling airflow annularly around a circumference of the cosmetic article being printed to cool, fuse and harden the build material after the build material is deposited.

17. The device of claim 16 wherein the means for cooling includes a fan in fluid communication with an air intake, a duct and an air outlet, the fan conducting air from the intake through the duct to the outlet, the outlet adapted to direct the air annularly around the circumference of the article being printed.

18. The device of claim 17 wherein the outlet has a circular configuration and is positioned around a perimeter of the nozzle and the air is directed downwardly.

19. The device of claim 1 wherein the nozzle further comprises a hemispherical chamber for receiving build material from the reservoir prior to extrusion.

20. The device of claim 19 wherein the hemispherical chamber is a melting chamber.

21. The device of claim 1 wherein the substrate is selected from one of a plate, a cup and a pan.

22. The device of claim 17 wherein the duct further comprise internal baffles adapted to create a uniform outflow from the air outlet.

23. The device of claim 17 wherein the air outlet has a circular configuration.

24. The device of claim 17 wherein the fan is a variable speed fan, and the device further comprises a switch for selecting a speed of the fan to adjust the rate of cooling of the article being printed.

25. A device for printing a three dimensional cosmetic article from a build material comprising a cosmetic formula, the device comprising:
an extruder including:
a barrel having an inner wall defining a cylinder, the cylinder having a first end and a second end;
a piston mounted in the first end of the cylinder such that the piston is able to advance and retract in the cylinder, the piston having a front wall and a rear wall connected by an outwardly directed sidewall, the sidewall shaped and dimensioned to fit closely in the cylinder, the front wall of the piston directed toward the second end of the cylinder;
an nail secured to the second end of the cylinder, the nail defining a hemispherical chamber in fluid communication with the cylinder,
an extrusion nozzle secured to nail, the extrusion nozzle having a nozzle outlet at a distal end and a nozzle inlet at a proximal end, the hemispherical chamber in fluid communication with the nozzle inlet and the nozzle inlet in fluid communication with the nozzle outlet via a nozzle duct;
a reservoir for receiving a quantity of the build material, the reservoir defined by a portion of the cylinder between the front wall of the piston and hemispherical chamber of the nozzle, the piston adapted to apply pressure to the build material to advance the build material from the reservoir into the hemispherical chamber and extrude the build material through the nozzle outlet when the piston is advanced in the cylinder and to apply suction to the build material to withdraw the build material into the nozzle outlet when the piston is retracted in the cylinder; and
a motor connected to the piston to advance and retract the piston;
a build plate located below the nozzle;
a substrate for supporting the cosmetic article, the substrate selectively secured on the build plate between the build plate and the nozzle to receive the build material from the nozzle;
a positioning assembly that positions the nozzle relative to the build plate; and
a controller coupled in a communicating relationship with the extruder and the positioning assembly, the controller programmed to position the nozzle relative to the build plate and advance the build material through the nozzle to deposit the build material onto the substrate to fabricate the cosmetic article in a three dimensional shape.

26. The device of claim 21 further comprising a heating element proximal to the nozzle and adapted to melt the build material in the melting chamber.

27. A device for printing a three dimensional cosmetic article from a build material comprising a cosmetic formula, the device comprising:
an extruder adapted to heat and extrude the build material in a melted state through an extrusion nozzle;
a build plate located below the nozzle;
a substrate for supporting the cosmetic article, the substrate selectively secured on the build plate between the build plate and the nozzle to receive the build material from the nozzle;
a positioning assembly that positions the nozzle relative to the build plate; and
a controller coupled in a communicating relationship with the extruder and the positioning assembly, the controller programmed to position the nozzle relative to the build plate and advance the build material through the nozzle to deposit the build material onto the substrate to fabricate the cosmetic article in a three dimensional shape.

28. The device of claim 27 wherein the substrate is selected from one of a plate, a cup and a pan.

29. The device of claim 1 wherein the build plate further comprises a substrate recess cooperatively shaped to receive the substrate.

30. A device for printing a three dimensional cosmetic article from a build material comprising a cosmetic formula, the device comprising:
an extruder adapted to heat and extrude the build material in a melted state through an extrusion nozzle;
a build plate located below the nozzle;
a substrate for supporting the cosmetic article, the substrate having a shape and dimension, the substrate selectively secured on the build plate beneath the nozzle to receive the build material from the nozzle;
a positioning assembly that positions the nozzle relative to the build plate;
a controller coupled in a communicating relationship with the extruder and the positioning assembly, the controller programmed to position the nozzle relative to the build plate and advance the build material through the nozzle to deposit the build material onto the substrate to fabricate the cosmetic article in a three dimensional shape; and
a sizing recess in the build plate, the sizing recess shaped and dimensioned to be larger the substrate, the sizing recess shaped and dimensioned to receive a correspondingly shaped and dimensioned sizing insert, the insert secured to the build plate, the insert having a substrate void cooperatively shaped and dimensioned to receive a correspondingly shaped and dimensioned substrate.

31. The device of claim 2 wherein the stick has a width in the range of 0.125 inches to 3 inches and a length in the range of 0.5 inches to 12 inches.

32. The device of claim 2 wherein the stick has a round cross-section, a width of 0.5 inches and a length of 4 inches.
